(19) United States
(12) Patent Application Publication
(10) Pub. No.: US 2013/0191156 A1
(43) Pub. Date: Jul. 25, 2013

(54) SYSTEM AND METHOD FOR PROVIDING MEDICAL WORKER COLLABORATION

(71) Applicant: WELLPOINT, INC., Chicago, IL (US)

(72) Inventors: Prakash Upadhyayula, Plainfield, IL (US); Aruna Guruprasad, Lodi, NJ (US); Andrew J. Lang, Avon, CT (US)

(73) Assignee: WELLPOINT, INC., Chicago, IL (US)

(21) Appl. No.: 13/743,752

(22) Filed: Jan. 17, 2013

Related U.S. Application Data
(60) Provisional application No. 61/587,715, filed on Jan. 18, 2012.

(51) Int. Cl. G06Q 10/10; G06Q 50/24

(52) U.S. Cl. CPC G06Q 10/10; G06Q 50/24
USPC 705/3

(57) ABSTRACT

A collaborative electronic environment for medical workers. First medical worker data, describing a medical condition of a patient and (1) a diagnosis relating to the medical condition associated with a first medical worker; and/or (2) a treatment relating to the medical condition associated with the first medical worker, is maintained in a data repository. Second medical worker data describing one or more of (1) an additional diagnosis relating to the medical condition; (2) an additional treatment relating to the medical condition; (3) commentary regarding the diagnosis; and (4) commentary regarding the treatment, is received from a second medical worker, through the electronic user interface. The second medical worker data is stored in the data repository. At least some of the first medical worker data and at least some of the second medical worker data is displayed in the electronic user interface.

### CROSS REFERENCE TO RELATED APPLICATIONS

This application claims priority to U.S. Provisional Patent Application No. 61/587,715, filed Jan. 18, 2012, the entirety of which is incorporated herein by reference.

### FIELD OF THE INVENTION

The systems and methods described herein relate providing a collaborative electronic environment for medical workers.

### SUMMARY OF EMBODIMENTS OF THE INVENTION

The present invention is directed to systems, methods and computer-readable media for use in connection with providing a collaborative electronic environment for medical workers. First medical worker data, describing a medical condition of a patient and (1) a diagnosis relating to the medical condition associated with a first medical worker; and/or (2) a treatment relating to the medical condition associated with the first medical worker, is maintained in a data repository. Second medical worker data describing one or more of (1) an additional diagnosis relating to the medical condition; (2) an additional treatment relating to the medical condition; (3) commentary regarding the diagnosis; and (4) commentary regarding the treatment, is received from a second medical worker, through the electronic user interface. The second medical worker data is stored in the data repository. At least some of the first medical worker data and at least some of the second medical worker data is displayed in the electronic user interface.

### BRIEF DESCRIPTION OF THE DRAWINGS

FIG. 1 is a diagram illustrating an example of the functionality that may be employed in connection with the decision support system of one embodiment of the present invention;

FIGS. 2A and 2B are flow charts illustrating exemplary methods of the present invention;

FIGS. 3A-3D are exemplary user interfaces that may be used in connection with an exemplary embodiment of the present invention;

FIG. 4 is a flow chart illustrating an exemplary method of the present invention;

FIG. 5 is a diagram of an exemplary system that may be used to carry out the processes of an embodiment of the present invention; and

FIG. 6 is a diagram of an exemplary system illustrating exemplary computer hardware and software components that may be used in connection with an embodiment of the present invention.

### DETAILED DESCRIPTION

The systems described herein implement an information rendering process that facilitates making of evidence-based decisions, providing user-friendly and intuitive interfaces to aid in such processes. The information rendering process may be integrated with machine learning to facilitate efficient decisioning through automated decision recommendation display, and also allows for tracking user behavior during the process. The information rendering process may also quantify behavior of decision makers through definition of specific behavior tracking metrics, decision trend measurements, and instrumentation for calibrating measurements.

More particularly, the systems describe herein provide medical workers (e.g., physicians) with access to information regarding medical diagnoses and treatments in progress, both by themselves and by other physicians, on the same patient at anytime. The physician/provider can access the Review Active Patient Cases functionality either during the Create Case process where the treatments suggested by the system or by another physician are displayed or from other navigation portions of the interface. The provider/provider can look up the patient by searching on basic patient information such as Member Id, Member Last name, Member First Name, or Member DOB, by way of example. The physician/provider can review the listing of all active cases, and thus become aware of all active treatment considerations in progress for the patient, and relate those to suggested treatment, accordingly. The provider can also invoke the “Physician Collaboration” functionality from this listing, which allows the physician to collaborate with other physicians. The system displays a listing of all active cases with supporting details about the case, including status and attending physician. It allows the user to select a case to get more detailed information and the current treatments suggested or being considered for that case, and allows the physicians to collaborate with other physicians working with member/patient using the messaging functionality. The service authenticates the request, validates the information received, handles persistence of the request and response between the application and the data store. The data store acts as the source of information on other active cases, and the feedback of the attending physicians on those cases. This functionality is described in more detail below.

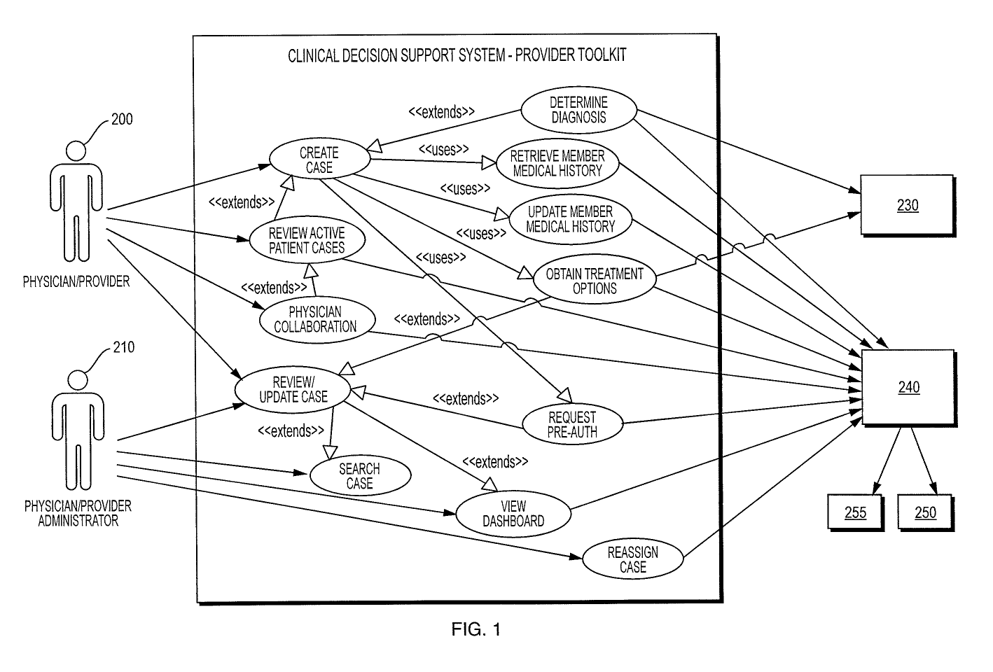

By way of example of how the decision support information rendering system can be used, reference is made to FIG. 1. A physician user 200 may create cases, review active cases, collaborate with other physicians and review/update cases. An administrative user 200 may review/update cases, as well as search for cases, view dashboards, and reassign cases. Evidence based decision intelligence system 230 may be employed by a user in connection with determining diagnoses and obtaining information regarding treatment options. Clinical Diagnosis Support System (CDSS) service 240 may be employed by a user in connection with determining diagnoses, retrieving member medical history information, updating member medical history, obtaining treatment options, requesting preauthorization, viewing dashboards and reassigning cases. CDSS service 240 stores data in and retrieves data from data store 250 and electronic medical record system 255.

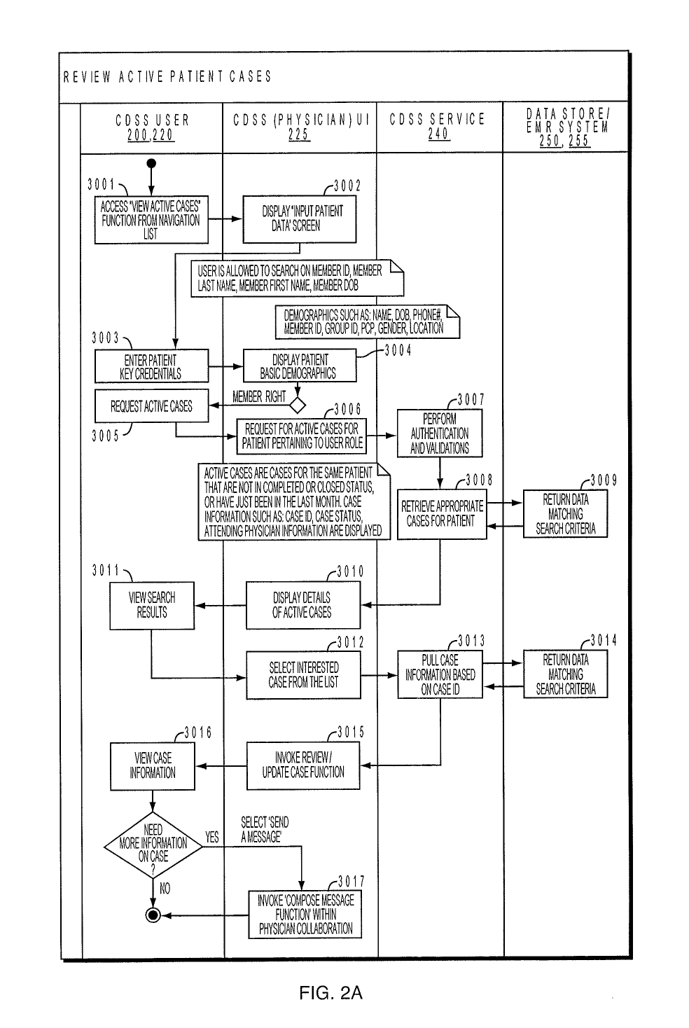

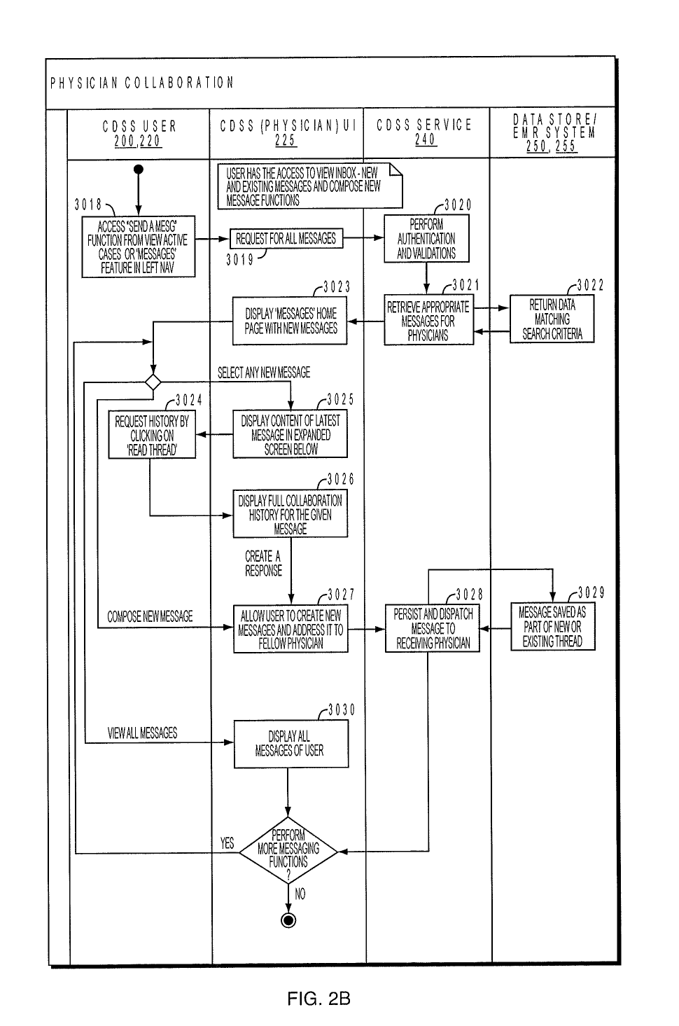

FIG. 2A is a flow chart illustrating an exemplary workflow for reviewing active cases. In step 3001, the user 200/220 may access the “View Active Cases” function from the navigation list. In step 3002, the user interface 225 displays the “Input Patient Data” screen. In step 3003, the user 200/220 enters the patient's credentials. In step 3004, the user interface 225 displays the patient's basic demographic information. Assuming the patient is the one of interest, in step 3005, the user 200/220 may request active cases for that patient. In step 3006, the user interface 225 makes a request for active cases for the patient, in accordance with the role of the user 200/220. In step 3007, CDSS service 240 performs authentication and validation. In step 3008, the CDSS service 240 retrieves the cases for the patient. In step 3009, data store 250/electronic medical record system 255 returns data matching the search criteria. In step 3010, the user interface 225 displays the details of the active cases. In step 3011, the user 200/220 views the search results. In step 3012, the user interface 225 is used to select the case of interest to the user 200/220 from the list. In step 3013, the CDSS service 240 pulls case information based on the case identifier. In step 3014, the data store 250/electronic medical record system 255 returns data matching the search criteria. In step 3015, the user interface 225 invokes the review/update case function. In step 3016, the user 200/220 views the case information. In some instances, if a physician user 200 needs more information about a case, or would like to collaborate with other physicians about the case, in step 3017, he may invoke the “Compose Message Function” within the physician collaboration functionality provided for by the system, and described in more detail with reference to FIG. 2B.

FIG. 2B is a flow chart illustrating an exemplary method used in connection with the physician collaboration functionality. In step 3018, the user 220/200 can the send a message using the “View Active Cases” screen functionality or using the “Messages” feature. The user interface 225 displays to the user 220/200 a mail box. Here, the user 220/200 has access to his inbox (new and existing messages), can request all messages, in step 3019, and can compose new messages. In step 3020, CDSS service 240 performs authentication and validation. In step 3021, CDSS service 240 retrieves the appropriate messages for the physician. In step 3022, data store 250/EMR system 255 returns data matching the search criteria. In step 3023, the user interface 225 displays the “Messages” home page with new messages. At this point, several options are available to the user 220/200.

For example, the user may select any new message. In step 3025, the user interface 225 displays the content of the latest message in an expanded screen. In step 3024, the user may request the history by clicking on the “Read Thread” functionality. In step 3026, the user interface 225 displays the full collaboration history for the given message. The user interface 225 may allow the user to create a new message and address it to a fellow physician, in step 3027. In step 3028, CDSS service 240 may persist the message and dispatch it to the intended recipient physician. In step 3029, the data store 250/EMR system 255 saves the message as part of a new or existing message thread. By way of further example, the user 200/220 can compose a new message directly, referring back to the functionality referenced in steps 3027, 3028, and 3029. By way of still further example, the user 200/220 can view all messages, in which cases user interface 225 displays all messages to the user in step 3030. Other messaging functions may also be available to the user 200/220.

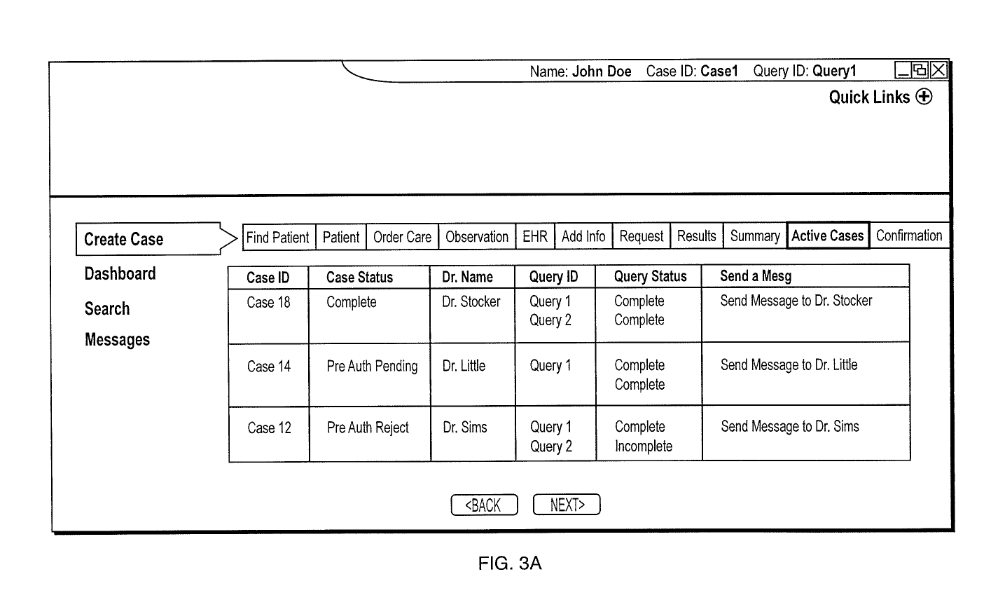

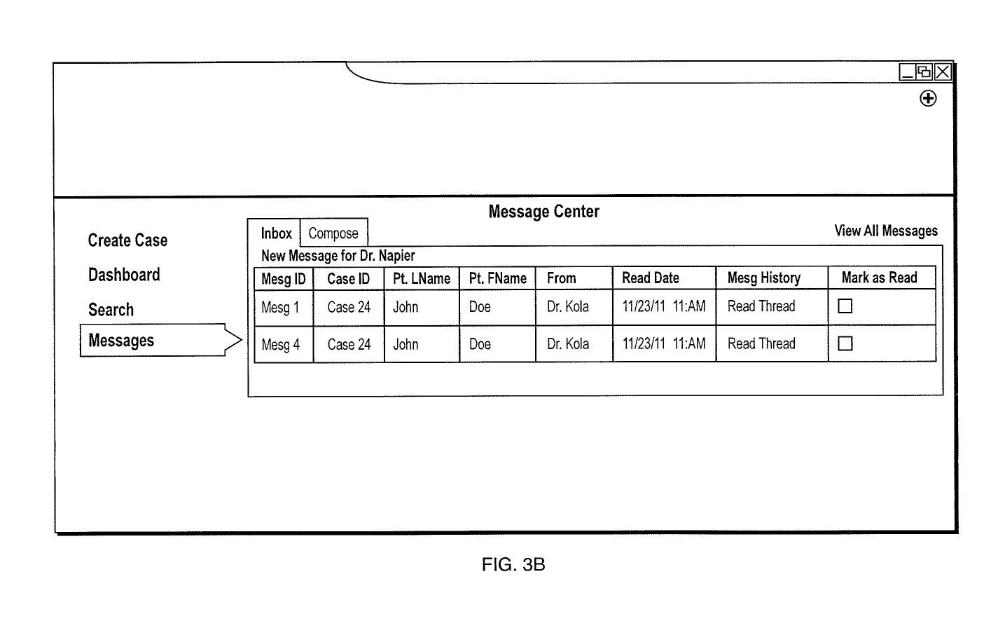

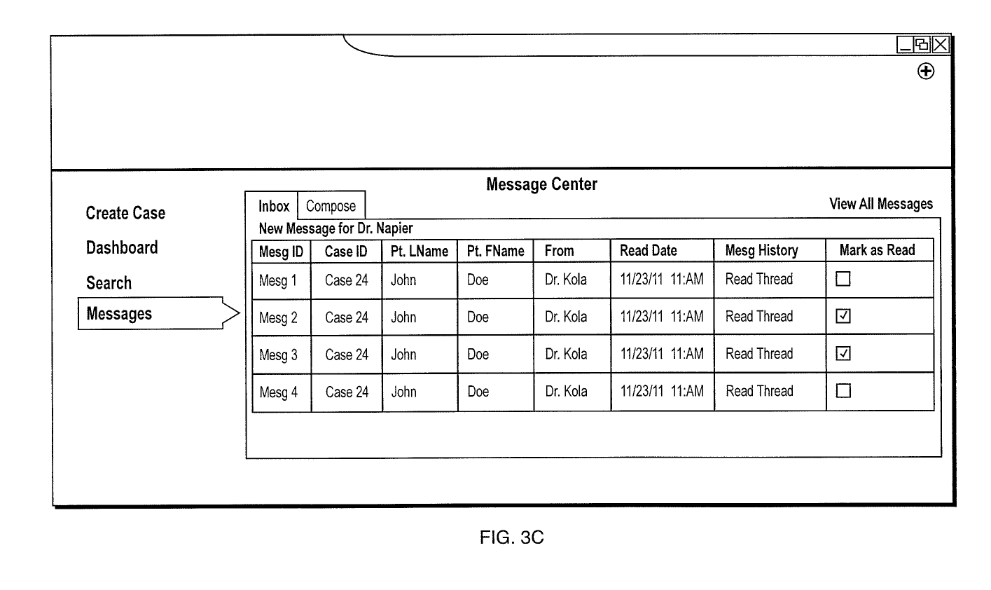

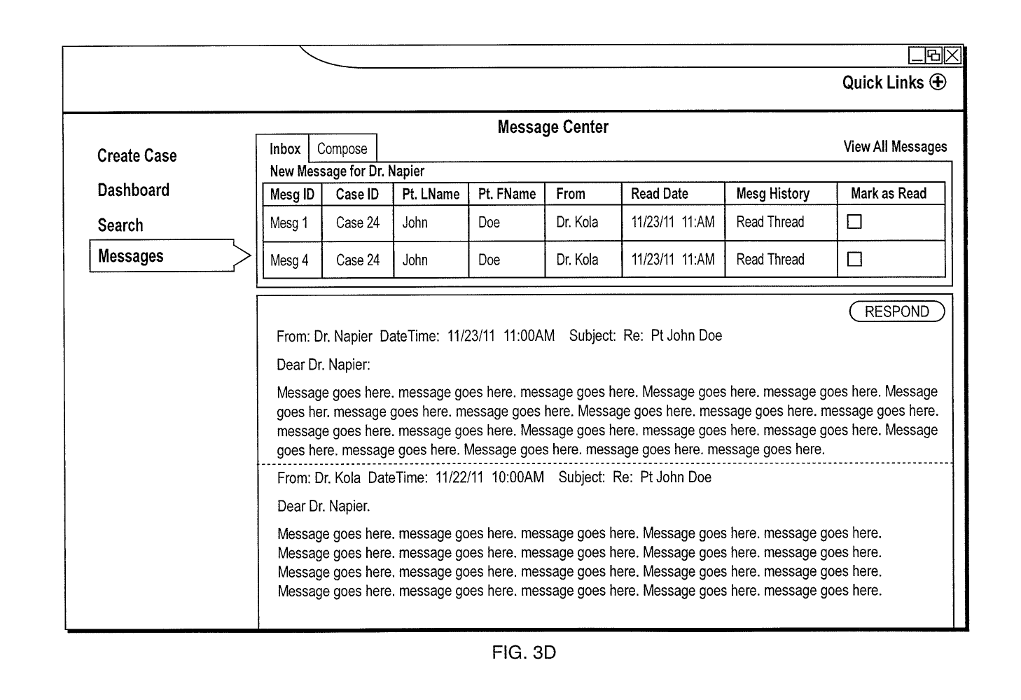

The screens illustrated with reference to FIGS. 3A-3D provides examples of the screens that may be used in connection with the present invention, allowing a provider/physician to review details of active cases on the current member/patient in consideration, in addition to/other than his own, through the CDSS.

FIG. 3A illustrates an exemplary Active Patient Cases Screen. The physician/provider can click on any case to find more information about it, or use the “Send a Mesg” function to collaborate with other physicians.

FIGS. 3B-3D illustrate exemplary screens that can be used in connection with physician collaboration, which allows the providers/physicians to collaborate with each other on common patient cases through the CDSS. The physician/provider can view new and/or read messages from other doctors and expand further into the complete message thread. They can also respond to received messages, or create new messages to be sent to other physicians to collaborate on common cases. The system can display the messages list (new and all), allowing the user to review complete threads or create and dispatch new messages. The CDSS service 240 authenticates the request, validates the information received, and handles persistence and retrieval of messages between the application and the data store. The data store captures and stores all messages generated and dispatched for further retrieval and display.

As shown in FIG. 3B, the physician/provider can click on any message from Inbox to review, or get to the history, or Compose New message. As shown in FIG. 3C, the physician/provider can click on “View All Messages” to retrieve new and read messages from the system. With reference to FIG. 3D, the physician/provider can expand on any message to retrieve the complete history or to respond to the message.

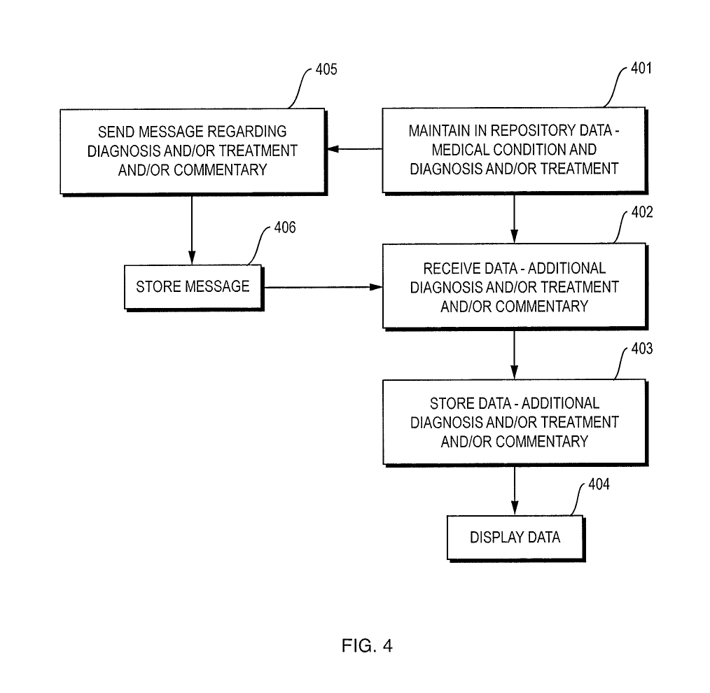

With reference to FIG. 4, an exemplary method is illustrated. In step 401, first medical worker data, describing a medical condition of a patient and (1) a diagnosis relating to the medical condition associated with a first medical worker; and/or (2) a treatment relating to the medical condition associated with the first medical worker, is maintained in a data repository. Such data may be self reported by the patent and/or may originate from, e.g., the records of a health insurer of the patient or the records of the first medical worker or other medical worker who has examined or treated the patient (e.g., an electronic medical record or EMR). In step 402, second medical worker data describing one or more of (1) an additional diagnosis relating to the medical condition; (2) an additional treatment relating to the medical condition; (3) commentary regarding the diagnosis; and (4) commentary regarding the treatment is received from a second medical worker, through the electronic user interface. Thus, a second medical worker may provide an additional or different diagnosis, based on the information he reviews in the patient's electronic medical record, or a recommendation for an additional or different treatment. The second medical worker may also provide comments on the diagnosis rendered by the first medical worker and/or treatment ordered or rendered by the first medical worker. In step 403, the second medical worker data is stored in the data repository, thereby making the patient's EMR more robust and comprehensive. In step 404, at least some of the first medical worker data and at least some of the second medical worker data are displayed in the electronic user interface. Thus, as the care cycle for the patient continues, an electronic record is created and made available to multiple medical workers (e.g., physicians) through the systems described herein.

In some embodiments, the first medical worker is a treating physician of the patient and the second medical worker is a non-treating physician of the patient. In other embodiments, the first and second medical worker are treating physicians.

In some embodiments, in step 405, the first medical worker sends to the second medical worker, through the electronic user interface, one or more electronic messages requesting the second medical worker to provide the second medical worker data. In these embodiments, in step 406, the one or more electronic messages from the first medical worker to the second medical worker are stored in the repository, thereby creating a reproducible record thereof. As part of step 404, the one or more electronic messages from the first medical worker to the second medical worker are displayed on the user interface. Again, as described above, this allows for establishing a comprehensive medical record for the patient, including the diagnoses and treatments for the patient, through the course of care, associated with and/or rendered by multiple physicians, even if the physicians are not part of the same practice or have not examined or are providing treatment for the patient. Providers/physicians are thus given electronic access to wealth of relevant information, pertaining to the patient over time, consolidated in a single location, thereby allowing them to make better and more informed decisions about treatment.

In other embodiments, data describing at least one additional medical condition of the patient and one or both of (1) a diagnosis relating to one or more of the additional medical conditions associated with the first medical worker or a third medical worker and (2) a treatment relating to one or more of the additional medical conditions associated with the first medical worker or the third medical worker is maintained in the data repository, e.g., as part of step 401. In these embodiments, as part of step 405, the first medical worker, the second medical worker and/or the third medical worker send one or more electronic messages, through the electronic user interface, regarding one or both of (1) the diagnoses relating to one or more of the additional medical conditions or (2) the treatment relating to one or more of the additional medical conditions. In such embodiments, as part of step 406, the one or more electronic messages from the one or more of the first medical worker, the second medical worker and the third medical worker are stored in the repository.

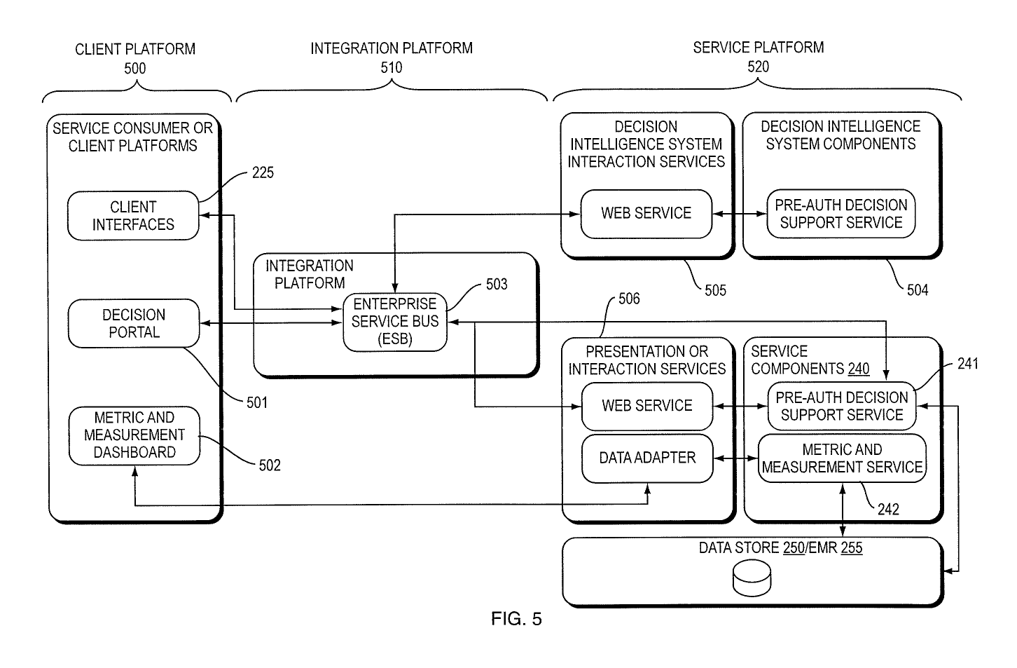

An exemplary system is now described with reference to FIG. 5. The system may comprise three platforms: a client platform 500, an integration platform 510, and a service platform 520. The client platform 500 may include the client interfaces (e.g., user interface 225), the decision portal 501 and the metric and measurement dashboard 502. The integration platform 510 may include an enterprise service bus 503. Service platform 520 may include CDSS service 240, which may include interaction services 241 and system components 242, and evidence based decision intelligence system 504, which may include interaction services 505 and system components 506. Service platform 520 may also include data store 250/EMR store 255.

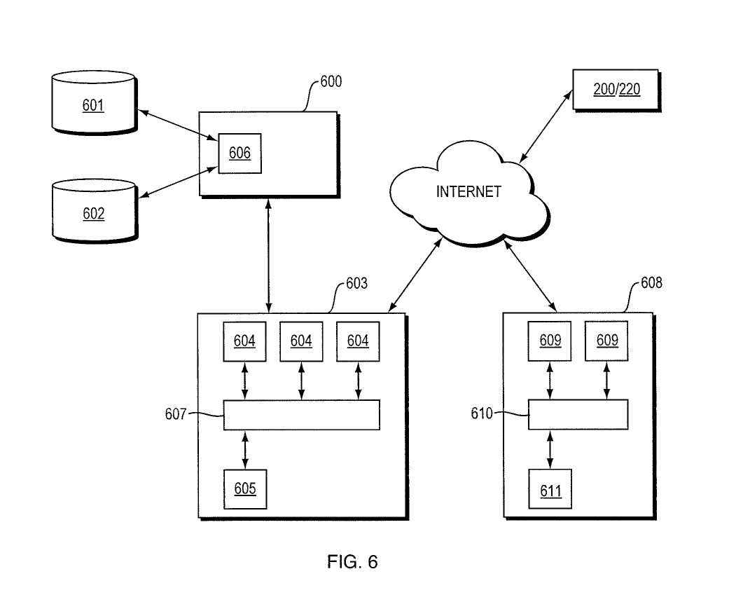

Exemplary hardware and software employed by the systems discussed herein are now generally described with reference to FIG. 6. Database server(s) 600 may include a database services management application 606 that manages storage and retrieval of data from the database(s) 601, 602. The databases may be relational databases; however, other data organizational structure may be used without departing from the scope of the present invention. One or more application server(s) 603 are in communication with the database server 600. The application server 603 communicates requests for data to the database server 600. The database server 600 retrieves the requested data. The application server 603 may also send data to the database server for storage in the database(s) 601, 602. The application server 603 comprises one or more processors 604, computer readable storage media 605 that store programs (computer readable instructions) for execution by the processor(s), and an interface 607 between the processor(s) 604 and computer readable storage media 605. The application server may store the computer programs referred to herein.

To the extent data and information is communicated over the Internet, one or more Internet servers 608 may be employed. The Internet server 608 also comprises one or more processors 609, computer readable storage media 611 that store programs (computer readable instructions) for execution by the processor(s) 609, and an interface 610 between the processor(s) 609 and computer readable storage media 611. The Internet server 608 is employed to deliver content that can be accessed through the communications network, e.g., by provider/physician user 200/220. When data is requested through an application, such as an Internet browser, the Internet server 608 receives and processes the request. The Internet server 608 sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

What is claimed is:

1. A computerized method comprising:
maintaining in a data repository first medical worker data describing a medical condition of a patient and one or both of (1) a diagnosis relating to the medical condition associated with a first medical worker; and (2) a treatment relating to the medical condition associated with the first medical worker;
receiving from a second medical worker, through the electronic user interface, second medical worker data describing one or more of (1) an additional diagnosis relating to the medical condition; (2) an additional treatment relating to the medical condition; (3) commentary regarding the diagnosis; and (4) commentary regarding the treatment;
storing in the data repository the second medical worker data; and
displaying in the electronic user interface at least some of the first medical worker data and at least some of the second medical worker data.

2. The method of claim 1 wherein the first medical worker is a treating physician of the patient and wherein the second medical worker is a non-treating physician of the patient.

3. The method of claim 1 further comprising:
sending by the first medical worker to the second medical worker, through the electronic user interface, one or more electronic messages requesting the second medical worker to provide the second medical worker data;
storing the one or more electronic messages from the first medical worker to the second medical worker in the repository; and
displaying the one or more electronic messages from the first medical worker to the second medical worker.

4. The method of claim 1 further comprising:
maintaining in the repository data describing at least one additional medical condition of the patient and one or both of (1) a diagnosis relating to one or more of the additional medical conditions associated with the first medical worker or a third medical worker and (2) a treatment relating to one or more of the additional medical conditions associated with the first medical worker or the third medical worker.

5. The method of claim 4 further comprising:
sending by one or more of the first medical worker, the second medical worker and the third medical worker one or more electronic messages, through the electronic user interface, regarding one or both of (1) the diagnoses relating to one or more of the additional medical conditions or (2) the treatment relating to one or more of the additional medical conditions; and
storing the one or more electronic messages from the one or more of the first medical worker, the second medical worker and the third medical worker in the repository.

6. A non-transitory computer-readable storage medium that stores instructions which, when executed by one or more processors, cause the one or more processors to perform a method comprising:
maintaining in a data repository first medical worker data describing a medical condition of a patient and one or both of (1) a diagnosis relating to the medical condition associated with a first medical worker; and (2) a treatment relating to the medical condition associated with the first medical worker;
receiving from a second medical worker, through the electronic user interface, second medical worker data describing one or more of (1) an additional diagnosis relating to the medical condition; (2) an additional treatment relating to the medical condition; (3) commentary regarding the diagnosis; and (4) commentary regarding the treatment;
storing in the data repository the second medical worker data; and
displaying in the electronic user interface at least some of the first medical worker data and at least some of the second medical worker data.

7. The non-transitory computer-readable storage medium of claim 6 wherein the first medical worker is a treating physician of the patient and wherein the second medical worker is a non-treating physician of the patient.

8. The non-transitory computer-readable storage medium of claim 6, the method further comprising:
sending by the first medical worker to the second medical worker, through the electronic user interface, one or more electronic messages requesting the second medical worker to provide the second medical worker data;
storing the one or more electronic messages from the first medical worker to the second medical worker in the repository; and
displaying the one or more electronic messages from the first medical worker to the second medical worker.

9. The non-transitory computer-readable storage medium of claim 6, the method further comprising:
maintaining in the repository data describing at least one additional medical condition of the patient and one or both of (1) a diagnosis relating to one or more of the additional medical conditions associated with the first medical worker or a third medical worker and (2) a treatment relating to one or more of the additional medical conditions associated with the first medical worker or the third medical worker.

10. The non-transitory computer-readable storage medium of claim 9, the method further comprising:
sending by one or more of the first medical worker, the second medical worker and the third medical worker one or more electronic messages, through the electronic user interface, regarding one or both of (1) the diagnoses relating to one or more of the additional medical conditions or (2) the treatment relating to one or more of the additional medical conditions; and
storing the one or more electronic messages from the one or more of the first medical worker, the second medical worker and the third medical worker in the repository.

11. A system comprising:
memory operable to store at least one program; and
at least one processor communicatively coupled to the memory, in which the at least one program, when executed by the at least one processor, causes the at least one processor to:
maintain in a data repository first medical worker data describing a medical condition of a patient and one or both of (1) a diagnosis relating to the medical condition associated with a first medical worker; and (2) a treatment relating to the medical condition associated with the first medical worker;
receive from a second medical worker, through the electronic user interface, second medical worker data describing one or more of (1) an additional diagnosis relating to the medical condition; (2) an additional treatment relating to the medical condition; (3) commentary regarding the diagnosis; and (4) commentary regarding the treatment;
store in the data repository the second medical worker data; and
display in the electronic user interface at least some of the first medical worker data and at least some of the second medical worker data.

12. The system of claim 11 wherein the first medical worker is a treating physician of the patient and wherein the second medical worker is a non-treating physician of the patient.

13. The system of claim 11 wherein the processor is further caused to:
send by the first medical worker to the second medical worker, through the electronic user interface, one or more electronic messages requesting the second medical worker to provide the second medical worker data;
store the one or more electronic messages from the first medical worker to the second medical worker in the repository; and
display the one or more electronic messages from the first medical worker to the second medical worker.

14. The system of claim 11 wherein the processor is further caused to:
maintain in the repository data describing at least one additional medical condition of the patient and one or both of (1) a diagnosis relating to one or more of the additional medical conditions associated with the first medical worker or a third medical worker and (2) a treatment relating to one or more of the additional medical conditions associated with the first medical worker or the third medical worker.

15. The system of claim 14 wherein the processor is further caused to:
send by one or more of the first medical worker, the second medical worker and the third medical worker one or more electronic messages, through the electronic user interface, regarding one or both of (1) the diagnoses relating to one or more of the additional medical conditions or (2) the treatment relating to one or more of the additional medical conditions; and
store the one or more electronic messages from the one or more of the first medical worker, the second medical worker and the third medical worker in the repository.
